(19) United States
(12) Patent Application Publication
(10) Pub. No.: US 2025/0052875 A1
(43) Pub. Date: Feb. 13, 2025

(54) ANOMALY DETECTION DEVICE AND ANOMALY DETECTION METHOD

(71) Applicant: Panasonic Automotive Systems Co., Ltd., Kanagawa (JP)

(72) Inventors: Tomonori MITSUGI, Tokyo (JP); Ryo HIRANO, Kanagawa (JP); Tomoyuki HAGA, Nara (JP); Yuishi TORISAKI, Osaka (JP); Kaoru YOKOTA, Hyogo (JP)

(73) Assignee: Panasonic Automotive Systems Co., Ltd., Kanagawa (JP)

(21) Appl. No.: 18/789,973

(22) Filed: Jul. 31, 2024

(30) Foreign Application Priority Data
Aug. 10, 2023 (JP) 2023-131646

(51) Int. Cl. G01S 7/52; G01S 7/02; G01S 13/06; G01S 13/88; G01S 15/06; G01S 15/88; G01S 17/06; G01S 17/88

(52) U.S. Cl. CPC G01S 7/52001; G01S 7/021; G01S 13/06; G01S 13/88; G01S 15/06; G01S 15/88; G01S 17/06; G01S 17/88

(57) ABSTRACT

An anomaly detection device includes a processor and a non-transitory memory that stores a program. The processor executes the program to operate an anomaly detection device as an obtainer that obtains a first object detection result generated by a first object detection device that is included in a first apparatus which is a vehicle and detects an object in the vicinity of the first apparatus and a second object detection result generated by a second object detection device that is included in a second apparatus in the vicinity of the first apparatus and detects an object in the vicinity of the second apparatus; a determiner that determines whether at least one of the first apparatus or the second apparatus is being attacked, by comparing the first object detection result and the second object detection result; and an outputter that outputs a result of determination by the determiner.

### CROSS REFERENCE TO RELATED APPLICATION

The present application is based on and claims priority of Japanese Patent Application No. 2023-131646 filed on Aug. 10, 2023.

### FIELD

The present disclosure relates to an anomaly detection device and an anomaly detection method.

### BACKGROUND

Patent Literature (PTL) 1 discloses a technique of detecting a cyberattack by comparing information in the vicinity of own vehicle observed by another vehicle to a traveling state of the own vehicle.

### CITATION LIST

### Patent Literature

PTL 1: Japanese Unexamined Patent Application Publication No. 2019-129529

### SUMMARY

However, the technique according to PTL 1 can be improved upon.

In view of this, the present disclosure provides an anomaly detection device capable of improving upon the related art.

The anomaly detection device according to one aspect of the present disclosure includes a processor; and a non-transitory memory that stores a program. The processor executes the program to operate the anomaly detection device as: an obtainer that obtains a first object detection result generated by a first object detection device that is included in a first apparatus which is a vehicle and detects an object in the vicinity of the first apparatus, and a second object detection result generated by a second object detection device that is included in a second apparatus in the vicinity of the first apparatus and detects an object in the vicinity of the second apparatus; a determiner that determines whether at least one of the first apparatus or the second apparatus is being attacked, by comparing the first object detection result and the second object detection result; and an outputter that outputs a result of determination by the determiner.

The anomaly detection method according to one aspect of the present disclosure includes obtaining a first object detection result generated by a first object detection device that is included in a first apparatus which is a vehicle and detects an object in the vicinity of the first apparatus; obtaining a second object detection result generated by a second object detection device that is included in a second apparatus in the vicinity of the first apparatus and detects an object in the vicinity of the second apparatus; determining whether at least one of the first apparatus or the second apparatus is being attacked, by comparing the first object detection result and the second object detection result; and outputting a result of determination in the determining.

These general or specific aspects may be implemented by a system, a method, an integrated circuit, a computer program, or a non-transitory recording medium such as a computer-readable CD-ROM, or may be implemented by any combination of systems, methods, integrated circuits, computer programs, and non-transitory recording media.

The above aspects are capable of improving upon the related art.

### BRIEF DESCRIPTION OF DRAWINGS

These and other advantages and features of the present disclosure will become apparent from the following description thereof taken in conjunction with the accompanying drawings that illustrate a specific embodiment of the present disclosure.

FIG. 1 is a schematic view illustrating an anomaly detection system that detects an anomaly of a vehicle according to an embodiment.

FIG. 2 is a block diagram illustrating one example of the hardware configuration of a server according to the embodiment.

FIG. 3 is a block diagram illustrating one example of the hardware configuration of a vehicle according to the embodiment.

FIG. 4 is a block diagram illustrating one example of the functional configuration of an anomaly detection system according to the embodiment.

FIG. 5 is a diagram illustrating one example of an object detection result.

FIG. 6 is a diagram illustrating one example of vehicle data.

FIG. 7 is a diagram illustrating a first example of sensor data.

FIG. 8 is a diagram illustrating a second example of sensor data.

FIG. 9 is a diagram illustrating one example of positioning information.

FIG. 10 is a diagram illustrating one example of warning information.

FIG. 11 is a diagram illustrating one example of region information.

FIG. 12 is a diagram for illustrating a predetermined region defined by region information.

FIG. 13 is a flowchart illustrating one example of an anomaly detection method in the anomaly detection system according to the embodiment.

FIG. 14 is a diagram for illustrating a method of causing an object detection device to perform false detection.

FIG. 15 is a diagram for illustrating a method of causing the object detection device to perform false detection.

FIG. 16 is a diagram for illustrating a method of causing the object detection device to perform false detection.

FIG. 17 is a diagram for illustrating a principle to detect an attack that causes the vehicle to perform false detection of an object.

FIG. 18 is a diagram for illustrating a principle to detect an attack that causes the vehicle to perform false detection of an object.

FIG. 19 is a diagram for illustrating another example of the object detection result.

FIG. 20 is a diagram for illustrating another example of the object detection result.

FIG. 21 is a diagram for illustrating another example of the object detection result.

FIG. 22 is a block diagram illustrating one example of the functional configuration of an anomaly detection system according to Modification (1).

FIG. 23 is a flowchart illustrating one example of an anomaly detection method in the anomaly detection system according to Modification (1).

FIG. 24 is a diagram for illustrating an example of vehicles each including a plurality of various sensors.

### DESCRIPTION OF EMBODIMENT

### (Underlying Knowledge Forming Basis of the Present Disclosure)

The present inventors have found that the traditional technique described in “Background” has the following problems.

In the technique disclosed in PTL 1, a cyberattack is detected by comparing information in the vicinity of own vehicle observed by another vehicle and the traveling state of the own vehicle. In other words, the aim of the technique is to monitor whether the information of the vehicle is falsified or not.

Recently, some vehicles include an object detection device that detects objects in the vicinity of the vehicles, and use the detection results from the object detection device in travel control of the vehicles. In travel control using a detection result from an object detection device, for example, when an object that obstructs the travel of the vehicle is detected in the traveling direction of the vehicle, to avoid collision against the object, the steering angle of the vehicle is changed, or the travel of the vehicle is stopped. The present inventors have found that the vehicle including such an object detection device may be attacked to cause the object detection device to perform false detection and generate a detection result indicating that an object is not present in the vicinity of the vehicle even when the object is actually present in the vicinity of the vehicle, or conversely to cause the object detection device to perform false detection and generate a detection result indicating that an object is present in the vicinity of the vehicle even when the object is not present in the vicinity of the vehicle. When an attack to cause such false detection, it is possible to execute unintended control, for example, in spite of the presence of the object in front of the vehicle, the vehicle may travel forward as it is and collide with the object, or in spite of the absence of the object in front of the vehicle, travel of the vehicle may be stopped. Accordingly, it is necessary to detect an attack to cause false detection.

The present inventors, who have conducted extensive research, have found an anomaly detection device that can detect an attack that causes an object detection device of a vehicle to perform false detection.

The anomaly detection device according to a first aspect of the present disclosure includes a processor; and a non-transitory memory that stores a program. The processor executes the program to operate the anomaly detection device as: an obtainer that obtains a first object detection result generated by a first object detection device that is included in a first apparatus which is a vehicle and detects an object in the vicinity of the first apparatus, and a second object detection result generated by a second object detection device that is included in a second apparatus in the vicinity of the first apparatus and detects an object in the vicinity of the second apparatus; a determiner that determines whether at least one of the first apparatus or the second apparatus is being attacked, by comparing the first object detection result and the second object detection result; and an outputter that outputs a result of determination by the determiner.

In this configuration, by comparing the first object detection result and the second object detection result, it is determined whether at least one of the first apparatus or the second apparatus is being attacked. Thus, for example, if the first object detection result and the second object detection result are different, it can be detected that an attack to cause the object detection device to perform false detection is being executed. Thus, influences by an attack that causes the object detection device to perform false detection and affects travel control of the vehicle can be reduced.

The anomaly detection device according to a second aspect of the present disclosure is the anomaly detection device according to the first aspect, in which the obtainer successively obtains first object detection results successively generated by the first object detection device, and successively obtains second object detection results successively generated by the second object detection device, and the determiner successively determines whether at least one of the first apparatus or the second apparatus is being attacked, by successively comparing, among the first object detection results and the second object detection results successively obtained by the obtainer, a first object detection result and a second object detection result which are generated at timings corresponding to each other.

In this configuration, it can be successively detected that an attack that causes the object detection device to perform false detection is being executed.

The anomaly detection device according to a third aspect of the present disclosure is the anomaly detection device according to the first aspect, in which the obtainer further obtains a first position of the first apparatus when the first object detection device generates the first object detection result, and a second position of the second apparatus when the second object detection device generates the second object detection result, and the determiner determines whether at least one of the first apparatus or the second apparatus is being attacked, by comparing the first object detection result generated when the first position is included in a predetermined region and the second object detection result generated when the second position is included in the predetermined region.

In this configuration, for example, when the predetermined region is subjected to an attack that affects travel control of the vehicle and it is highly possible that the vehicle cannot travel normally, the attack can be detected. Thus, the possibility that the vehicle cannot travel normally can be reduced. The anomaly detection device according to a fourth aspect of the present disclosure is the anomaly detection device according to the first aspect, in which the determiner determines whether at least one of the first apparatus or the second apparatus is being attacked, by comparing the first object detection result and the second object detection result, the first object detection result indicating that an object is detected in a traveling direction of the first apparatus.

In this configuration, it can be determined whether the object detected by the first apparatus comes from false detection.

The anomaly detection device according to a fifth aspect of the present disclosure is the anomaly detection device according to any one of the first to fourth aspects, in which the determiner converts the first object detection result and the second object detection result into coordinates in a common coordinate system, and determines whether the first object detection result and the second object detection result after the conversion are different, and when the first object detection result and the second object detection result after the conversion are different, the determiner determines that at least one of the first apparatus or the second apparatus is being attacked.

In this configuration, by comparing the first object detection result and the second object detection result, it can be determined whether the objects detected by two easily apparatuses are the same. When the objects detected by two apparatuses are different, it can be determined that at least one of the first apparatus or the second apparatus is being attacked.

The anomaly detection device according to a sixth aspect of the present disclosure is the anomaly detection device according to a fifth aspect, in which the first object detection result indicates whether an object is present or not in each of a plurality of regions set in advance as a region in the vicinity of the first apparatus, and the second object detection result indicates whether an object is present or not in each of a plurality of regions set in advance as a region in the vicinity of the second apparatus.

In this configuration, by comparing the first object detection result and the second object detection result, it can be easily determined whether the objects detected by two apparatuses are the same.

The anomaly detection device according to a seventh aspect of the present disclosure is the anomaly detection device according to any one of the first to sixth aspects, in which the first object detection device includes a first sensor of a first type and a second sensor of a second type, the second object detection device includes a third sensor of the first type and a fourth sensor of the second type, the first object detection result includes a first detection result from the first sensor and a second detection result from the second sensor, the second object detection result includes a third detection result from the third sensor and a fourth detection result from the fourth sensor, the determiner compares the first detection result, the second detection result, the third detection result, and the fourth detection result, and when the determiner identifies one detection result different from three other detection results among four detection results including the first detection result, the second detection result, the third detection result, and the fourth detection result, the outputter notifies an other vehicle of a sensor type of the sensor from which the one detection result identified has been obtained.

The anomaly detection device according to an eighth aspect of the present disclosure is the anomaly detection device according to any one of the first to seventh aspects, in which the obtainer further obtains a third object detection result generated by a third object detection device that is included in a third apparatus which is a vehicle different from the first apparatus and detects an object in the vicinity of the third apparatus, and when the determiner compares the first object detection result, the second object detection result, and the third object detection result, and identifies one object detection result different from two other object detection results among three object detection results including the first object detection result, the second object detection result, and the third object detection result, the determiner determines that the apparatus including the object detection device from which the one object detection result identified has been obtained is being attacked.

The anomaly detection device according to a ninth aspect of the present disclosure is the anomaly detection device according to any one of the first to eighth aspects, in which the second apparatus is a vehicle or a roadside unit that is different from the first apparatus.

The anomaly detection method according to a tenth aspect of the present disclosure includes obtaining a first object detection result generated by a first object detection device that is included in a first apparatus which is a vehicle and detects an object in the vicinity of the first apparatus; obtaining a second object detection result generated by a second object detection device that is included in a second apparatus in the vicinity of the first apparatus and detects an object in the vicinity of the second apparatus; determining whether at least one of the first apparatus or the second apparatus is being attacked, by comparing the first object detection result and the second object detection result; and outputting a result of determination in the determining.

The program according to an eleventh aspect of the present disclosure is a program for causing a computer to execute the anomaly detection method according to the tenth aspect.

### EMBODIMENT

Hereinafter, an embodiment will be described using the drawings.

### [Configuration]

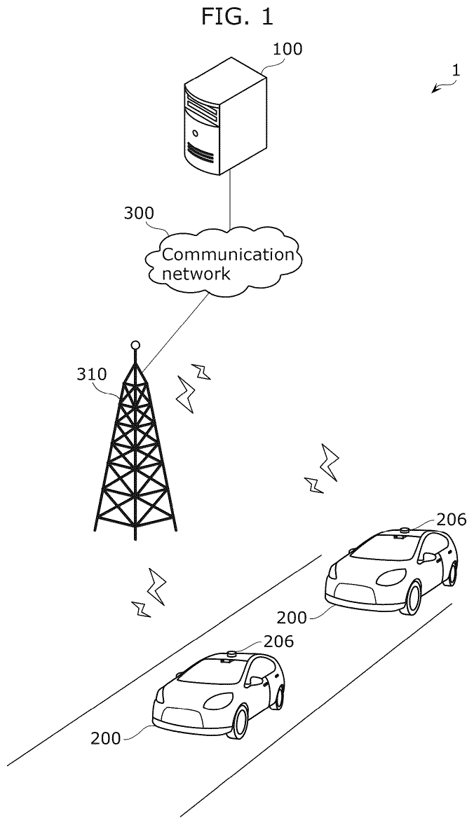

FIG. 1 is a schematic view illustrating an anomaly detection system that detects an anomaly of a vehicle according to an embodiment.

Specifically, in FIG. 1, server 100, two vehicles 200, communication network 300, and base station 310 of a moving body communication network are illustrated as components of anomaly detection system 1. Server 100 and two vehicles 200 are communicably connected via communication network 300 to transmit and receive information.

Server 100 is an apparatus that monitors states of two vehicles 200. Server 100 periodically obtains log information from two vehicles 200, and monitors the states of two vehicles 200 based on the obtained log information. When two vehicles 200 perform intra-vehicle communication, anomaly detection system 1 may be configured of only two vehicles 200.

Two vehicles 200 may perform not only communication via communication network 300 but also intra-vehicle communication. Although FIG. 1 illustrates two vehicles 200, three or more vehicles 200 are communicable with server 100 or another vehicle 200. Hereinafter, an example in which two vehicles 200 are present will be described.

Vehicle 200 includes a sensor that detects an object in the vicinity of vehicle 200, and controls traveling of vehicle 200 in response to an object detection result based on the result of detection by the sensor. The sensor that detects an object in the vicinity of vehicle 200 is Light Detection And Ranging (LiDAR) 206, sonar 207, or the like (see FIGS. 1 and 3), for example. Vehicle 200 may be an autonomous vehicle enabling autonomous driving, or may be a vehicle having Advanced Driver-Assistance Systems (ADAS) that assist driving of a driver, for example.

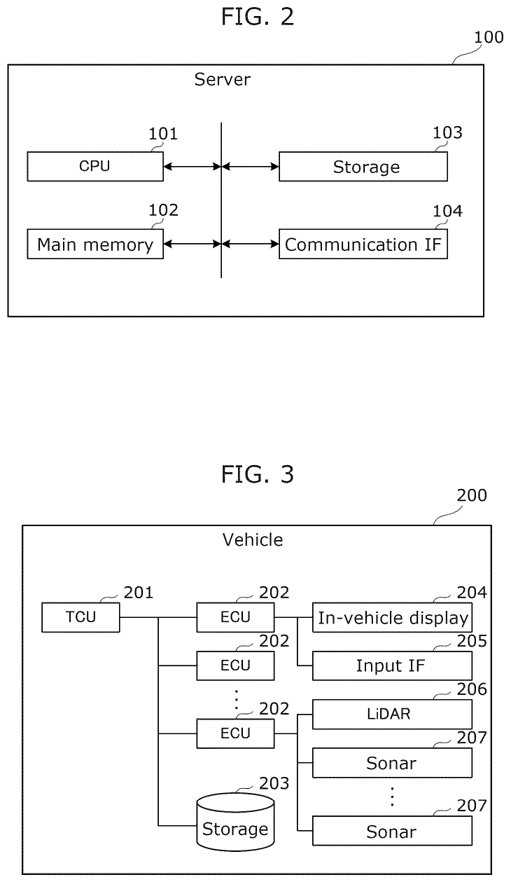

FIG. 2 is a block diagram illustrating one example of a hardware configuration of the server according to the embodiment.

As illustrated in FIG. 2, server 100 has a hardware configuration including central processing unit (CPU) 101, main memory 102, storage 103, and communication interface (IF) 104.

CPU 101 is a processor that executes a control program stored in storage 103 and the like.

Main memory 102 is a volatile storage region used as a working area when CPU 101 executes the control program.

Storage 103 is a non-volatile storage region that holds control programs, contents, and the like.

Communication IF 104 is a communication interface that communicates with two vehicles 200 via communication network 300. For example, communication IF 104 is a wired LAN interface. Communication IF 104 may be a wireless LAN interface. Communication IF 104 is not limited to an LAN interface, and may be any communication interface as long as it can establish connection of communication with the communication network.

FIG. 3 is a block diagram illustrating one example of a hardware configuration of a vehicle according to the embodiment.

As illustrated in FIG. 3, vehicle 200 has a hardware configuration including Telematics Control Unit (TCU) 201, a plurality of ECUs 202, storage 203, in-vehicle display 204, input interface (IF) 205, LIDAR 206, and a plurality of sonars 207.

TCU 201 is a communication unit through which vehicle 200 performs wireless communication with communication network 300. TCU 201 is a communication unit including a cellular module designated for standards of the moving body communication network.

The plurality of ECUs 202 each include a control circuit that obtains information from TCU 201, obtains the results of detection from a variety of sensors, and execute processings according to the obtained information or result of detection. At least one of the plurality of ECUs 202 is a control circuit that obtains the results of detection from a variety of sensors, and controls autonomous driving of vehicle 200 using the obtained results of detection. The plurality of ECUs 202 each also include a control circuit that executes control of in-vehicle display 204 included in vehicle 200 or other devices included in vehicle 200. Here, other devices include an engine, a motor, meters, a transmission, a brake, steering, power windows, an air conditioner, for example. The plurality of ECUs 202 may be each disposed corresponding to these various devices. Although not illustrated here, the plurality of ECUs 202 each may include a storage (non-volatile storage region) that stores programs to be executed by each ECU 202. The storage is a non-volatile memory, for example.

Storage 203 is a non-volatile storage region that holds control programs and the like. For example, storage 203 is implemented by a hard disk drive (HDD), a solid stated drive (SSD), or the like.

In-vehicle display 204 is disposed in the cabin of vehicle 200, and displays information expressed with characters or symbols to a user inside the cabin. In-vehicle display 204 may display an image. In-vehicle display 204 is a liquid crystal display, an organic EL display, or the like.

Input IF 205 is disposed in the cabin of vehicle 200, and accepts an input (operation) from the user inside the cabin. For example, input IF 205 may be a touch panel disposed on the surface of in-vehicle display 204, or may be a touch pad disposed in a region reached by the user sitting on a seat of vehicle 200.

LIDAR 206 is a sensor that detects the presence/absence of an object or the distance to the object by irradiating the object with laser light and measuring the time taken until the irradiated laser light is reflected from the object and returns. LIDAR 206 is disposed outside vehicle 200, and emits laser light in a plurality of specific directions in the vicinity of vehicle 200. The plurality of directions are defined by an angle (horizontal angle) in a reference direction (e.g., an anteroposterior direction) of vehicle 200 in top view of vehicle 200 and an angle (angle of elevation) in a reference direction (e.g., an anteroposterior direction) of vehicle 200 in lateral view of vehicle 200. In other words, the plurality of directions are each defined by a combination of a different horizontal angle and a different angle of elevation.

A plurality of sonars 207 are each a sensor that emits an ultrasonic wave in a specific direction, and detects the presence/absence of an object or the distance to the object based on the ultrasonic wave that is emitted in the specific direction, is reflected from the object, and returns. The plurality of sonars 207 are disposed outside vehicle 200, and measure the distance to an object approaching to vehicle 200. The plurality of sonars 207 are arranged in different positions in the vicinity of vehicle 200. The different positions in the vicinity of the vehicle indicate the center on the front side, the right on the front side, the left on the front side, the center on the rear side, the right on the rear side, and the left on the rear side of vehicle 200. Because the plurality of sonars 207 are arranged in different positions, the directions (specific directions) of the ultrasonic wave emitted are different from each other.

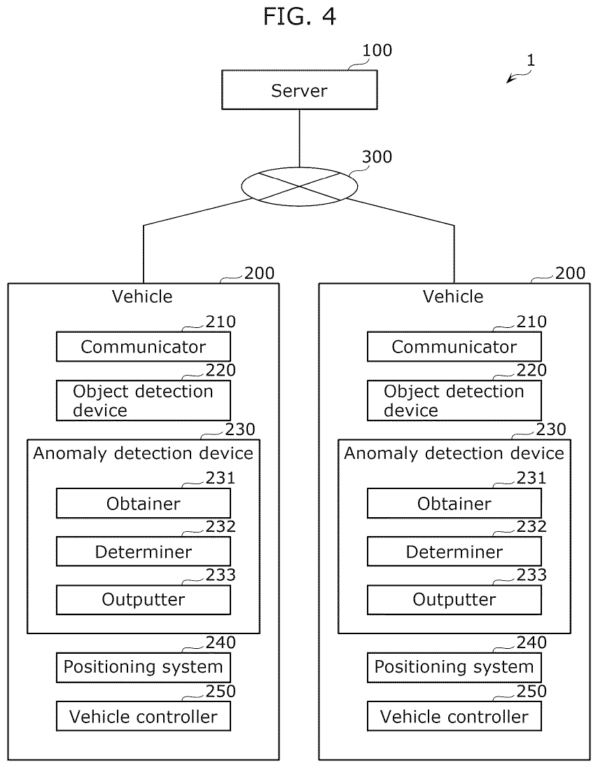

Next, the functional configuration of anomaly detection system 1 will be described. FIG. 4 is a block diagram illustrating one example of the functional configuration of the anomaly detection system according to the embodiment. In FIG. 4, illustration of communication network 300 is omitted.

As illustrated in FIG. 4, anomaly detection system 1 includes server 100 and two vehicles 200. Server 100 and two vehicles 200 are communicably connected via communication network 300. Hereinafter, the functional configuration of one of two vehicles 200 will be described. The functional configuration of other vehicle 200 have the same functional configuration as that of one vehicle 200, and thus the description thereof will be omitted. One vehicle 200 is referred to vehicle 200, and other vehicle 200 is referred to other vehicle 200. Vehicle 200 is one example of the first apparatus. Other vehicle 200 is one example of the second apparatus.

Vehicle 200 includes communicator 210, object detection device 220, anomaly detection device 230, positioning system 240, and vehicle controller 250.

Communicator 210 communicates with server 100 and other vehicle 200 via communication network 300. Communicator 210 may perform intra-vehicle communication with other vehicle 200. Thereby, communicator 210 transmits and receives information to and from server 100 and other vehicle 200. For example, communicator 210 obtains an object detection result (second object detection result), which is obtained by object detection device 220 (second object detection device) included in other vehicle 200, from other vehicle 200. Communicator 210 is implemented by TCU 201, for example.

Object detection device 220 detects an object in the vicinity of vehicle 200 including object detection device 220. Object detection device 220 may detect an object in the vicinity of vehicle 200 using the result of detection by LiDAR 206, or may detect an object in the vicinity of vehicle 200 using the result of detection by sonar 207. Since the result of detection by LiDAR 206 includes the distance to the object and the direction thereof, object detection device 220 may generate the result of detection by LIDAR 206 as it is as the object detection result. Since the result of detection by sonar 207 also includes the distance to the object and the direction thereof, object detection device 220 may generate the result of detection by sonar 207 as it is as the object detection result. Object detection device 220 may perform predetermined object recognition processing on at least one of the result of detection by LiDAR 206 or the result of detection by sonar 207, and may generate the result of processing as the object detection result. The object detection result includes a relative position of the object in the vicinity of vehicle 200 with respect to the referential position of vehicle 200. The relative position may be indicated by coordinates of an orthogonal coordinate system with respect to the referential position of vehicle 200, or may be indicated by coordinates of a polar coordinate system. The relative position may be indicated by information indicating the presence/absence of an object in each of a plurality of regions in the vicinity of vehicle 200. The term “the vicinity of vehicle 200” may indicate the vicinity of vehicle 200 in top view thereof. The predetermined object recognition processing may be processing using a machine learning model. Object detection device 220 is one example of the first object detection device. Object detection device 220 is implemented by at least one of LIDAR 206 or sonar 207 and ECU 202.

Object detection device 220 may detect the object in the vicinity of vehicle 200 not only using the result of detection by LIDAR 206 or sonar 207 but also a result of detection by a stereo camera (that is, a stereo image). For example, detection of the object in this case may use a three-dimensional model generated by performing feature point matching on a stereo image.

Anomaly detection device 230 is a device that detects an attack (anomaly) against at least one of vehicle 200 or other vehicle 200 by comparing an object detection result by object detection device 220 to an object detection result by object detection device 220 included in other vehicle 200. Anomaly detection device 230 includes obtainer 231, determiner 232, and outputter 233.

Obtainer 231 obtains a first object detection result generated by object detection device 220 (first object detection device) included in vehicle 200 and a second object detection result generated by object detection device 220 (second object detection device) included in other vehicle 200. Obtainer 231 successively obtains the first object detection results from object detection device 220. For example, when obtainer 231 obtains a plurality of first object detection results generated at different timings by detection processing in object detection device 220, obtainer 231 may obtain one first object detection result at a timing at which the first object detection result is generated. When obtainer 231 obtains a plurality of first object detection results generated at different timings by detection processing in object detection device 220, obtainer 231 may collectively obtain a plurality of first object detection results generated during the first period.

Obtainer 231 successively obtains second object detection results from other vehicle 200 via communicator 210. For example, when obtainer 231 obtains a plurality of second object detection results generated at different timings by detection processing in object detection device 220 of other vehicle 200, obtainer 231 may obtain one second object detection result at a timing at which the second object detection result is generated. When obtainer 231 obtains a plurality of second object detection results generated at different timings by detection processing in object detection device 220 of other vehicle 200, obtainer 231 may collectively obtain a plurality of second object detection results generated during the second period.

Obtainer 231 may obtain the second object detection result through intra-vehicle communication with other vehicle 200, or may obtain the second object detection result via communication network 300. When obtainer 231 obtains the second object detection result via communication network 300, vehicle 200 may obtain the second object detection result from other vehicle 200 located near the position of vehicle 200. The expression “located near the position of vehicle 200” indicates that other vehicle is included in a predetermined region when the position of vehicle 200 is regarded as a reference, and the predetermined region is a region within a predetermined radius from the position of vehicle 200 regarded as the center, for example. The predetermined radius may be determined according to the detection range of the sensor (LIDAR 206, sonar 207) included in vehicle 200. In other words, other vehicle 200 may be a vehicle which is located in a position to have a detection range overlapping the detection range of object detection device 220 included in vehicle 200.

By comparing the first object detection result to the second object detection result, determiner 232 determines whether at least one of vehicle 200 (first apparatus) or other vehicle 200 (second apparatus) is being attacked. By comparing the first object detection result and the second object detection result generated at timings corresponding to each other, determiner 232 successively determines that at least one of vehicle 200 or other vehicle 200 is being attacked. The first object detection result and the second object detection result generated at timings corresponding to each other may be the first object detection result and the second object detection result generated at timings close to each other among a plurality of first object detection results and a plurality of second object detection results obtained by obtainer 231. The first object detection result and the second object detection result generated at timings close to each other may be a combination of one of the first and second object detection results and different other object detection result obtained next to the other of the first and second object detection results, or may be a combination of the first and second object detection results whose timing difference is less than a predetermined period (for example, 1 second).

The first object detection result and the second object detection result may include timings at which the object detection results are detected. In this case, among a plurality of first object detection results and a plurality of second object detection results obtained by obtainer 231, determiner 232 may compare the first object detection result and the second object detection result generated at timings close to each other. The first object detection result and the second object detection result generated at timings close to each other may be a combination of the first and second object detection results whose timing difference is less than a predetermined period (for example, 1 second).

Determiner 232 converts the first object detection result and the second object detection result into coordinates in a common coordinate system, and determines whether the first object detection result and the second object detection result after the conversion are different. When the first object detection result and the second object detection result after the conversion are different, determiner 232 determines that at least one of vehicle 200 or other vehicle 200 is being attacked.

In this case, obtainer 231 obtains the second object detection result and the position of other vehicle 200 when the detection of the second object detection result is performed in other vehicle 200. For example, determiner 232 converts the second object detection result to a coordinate system where the position of vehicle 200 is regarded as a reference, using the second object detection result obtained from other vehicle 200, the position of other vehicle 200 when the detection of the second object detection result is performed in other vehicle 200, and the position of vehicle 200 when the detection of the second object detection result is performed in other vehicle 200. Thus, determiner 232 may convert the second object detection result to a coordinate system common to that of the first object detection result. When the first object detection result and the second object detection result are expressed in different systems such as an orthogonal coordinate system and a polar coordinate system, determiner 232 may convert the detection results to express the detection results in one of these coordinate systems.

Outputter 233 outputs the result of determination by determiner 232. For example, outputter 233 may display a screen including the result of determination on in-vehicle display 204. For example, outputter 233 may transmit the result of determination to other vehicle 200, may transmit the result of determination to server 100, or may transmit the result of determination to a terminal possessed by an user of vehicle 200 or a terminal possessed by user of other vehicle 200. The result of determination may include warning information. The warning information includes information indicating a possibility that vehicle 200 or other vehicle 200 is being attacked. The warning information may include information indicating which type of sensor is being attacked.

Anomaly detection device 230 is implemented by TCU 201, ECU 202, storage 203, or in-vehicle display 204, for example.

Positioning system 240 detects the position of vehicle 200. Positioning system 240 may be a Global Positioning System (GPS), or may be a positioning system using Simultaneous Localization and Mapping (SLAM).

Vehicle controller 250 performs autonomous driving control of vehicle 200 or control by ADAS. Vehicle controller 250 is implemented by a plurality of ECUs 202.

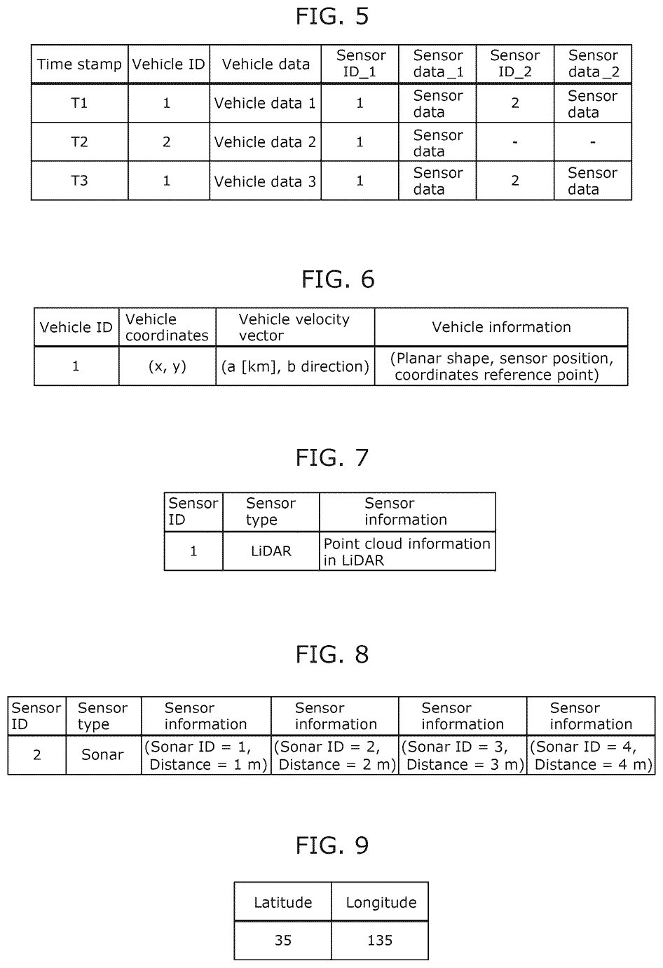

FIG. 5 is a diagram illustrating one example of the object detection result.

The object detection result illustrated in FIG. 5 includes the first object detection result and the second object detection result. One row of the object detection result represents one object detection result. The object detection result includes a time stamp, a vehicle ID, vehicle data, sensor ID_1, sensor data_1, sensor ID_2, and sensor data_2. The time stamp indicates a timing at which its corresponding object detection result is detected, or a timing at which its corresponding object detection result is generated. The vehicle ID indicates an identifier of the apparatus (vehicle) including the object detection device which generates its corresponding object detection result. The vehicle data indicates information concerning the apparatus (vehicle) including the object detection device which generates its corresponding object detection result. Sensor ID_1 indicates an identifier of a first sensor used in detection of an object by the object detection device which generates its corresponding object detection result. Sensor data_1 indicates the result of detection by a first sensor having sensor ID_1. Sensor ID_2 indicates an identifier of a second sensor used in detection of an object by the object detection device which generates its corresponding object detection result. Sensor data_2 indicates the result of detection by the second sensor having sensor ID_2. The first sensor and the second sensor may be sensors of different types. The first sensor may be LiDAR, for example, and the second sensor may be a sonar, for example.

FIG. 6 is a diagram illustrating one example of the vehicle data.

The vehicle data indicates the vehicle ID, the vehicle coordinates, the vehicle velocity vector, and vehicle information. The vehicle ID indicates the identifier of its corresponding vehicle. The vehicle coordinates indicate the position of the vehicle when its corresponding vehicle data is obtained. The vehicle velocity vector indicates the vehicle speed and the traveling direction of the vehicle when its corresponding vehicle data is obtained. The vehicle information includes the planar shape of the vehicle corresponding to the vehicle data, the positions of sensors, the coordinates reference point, and the like.

FIG. 7 is a diagram illustrating first example of the sensor data. FIG. 7 is an example of the sensor data when the sensor is LiDAR.

The sensor data includes a sensor ID, a sensor type, and sensor information. The sensor ID indicates an identifier of the sensor that detects its corresponding sensor data. The sensor type indicates the type of its corresponding sensor. The sensor information indicates the result of detection (raw data) detected by the sensor.

FIG. 8 is a diagram illustrating second example of the sensor data. FIG. 8 is an example of the sensor data when the sensor is a sonar.

The sensor data includes a sensor ID, a sensor type, and sensor information. The sensor ID indicates an identifier of the sensor that detects its corresponding sensor data. The sensor type indicates the type of its corresponding sensor. The sensor information indicates the results of detection (raw data) detected by a plurality of sensors included in the sensor ID.

FIG. 9 is a diagram illustrating one example of positioning information.

The positioning information indicates the position detected by positioning system 240 of vehicle 200. The positioning information includes the latitude and the longitude indicating the position of vehicle 200, for example.

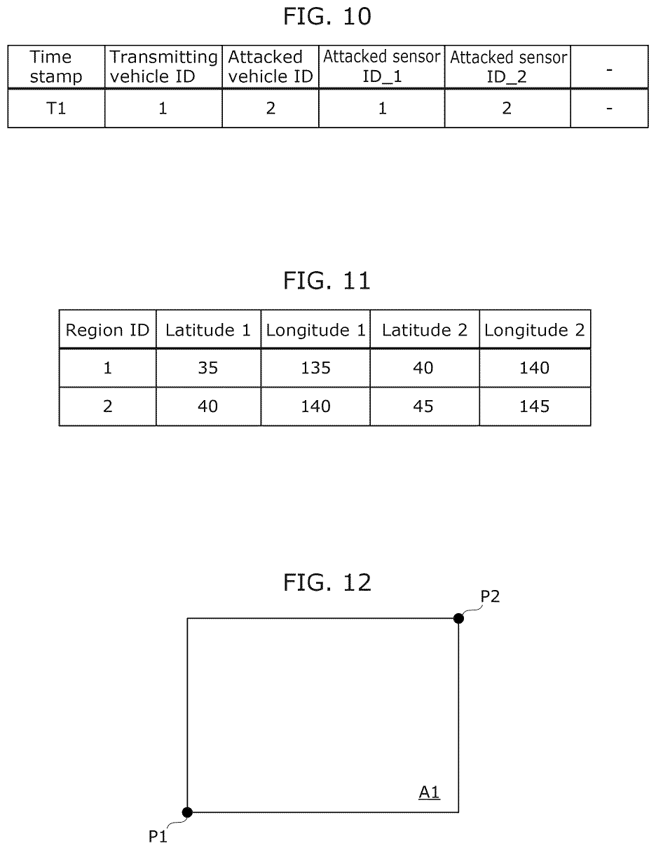

FIG. 10 is a diagram illustrating one example of the warning information.

The warning information includes a time stamp, a transmitting vehicle ID, an attacked vehicle ID, attacked sensor ID_1, and attacked sensor ID_2. The time stamp indicates the timing at which the warning information is generated. The transmitting vehicle ID indicates an identifier of the vehicle that transmits (generates) the warning information. The attacked vehicle ID indicates an identifier of the vehicle attacked. Attacked sensor ID_1 indicates the identifier of the sensor attacked. Attacked sensor ID_2 indicates the identifier of other sensor attacked.

FIG. 11 is a diagram illustrating one example of region information. FIG. 12 is a diagram for illustrating a predetermined region defined by the region information.

The region information is information preliminarily stored in storage 203 of vehicle 200. For example, the region information includes information for identifying a predetermined region. For example, the predetermined region is a region used in determination in step S11 described later and preliminarily defined as a region having a high possibility that vehicle 200 cannot normally travel when vehicle 200 is subjected to an attack which affects detection of an object. The predetermined region is a region where it is more likely that an accident by the vehicle occurs than in other regions. The region information includes an region ID, latitude 1, longitude 1, latitude 2, and longitude 2. The region ID is an identifier of the predetermined region. Latitude 1 and longitude 1 are information indicating the coordinates of point P1 at a corner of predetermined region A1 illustrated in FIG. 12. Latitude 2 and longitude 2 are information indicating the coordinates of point P2 diagonal to point P1 in predetermined region A1. As illustrated in FIG. 12, predetermined region A1 is a rectangular region defined by two points, points P1 and P2.

### Operation

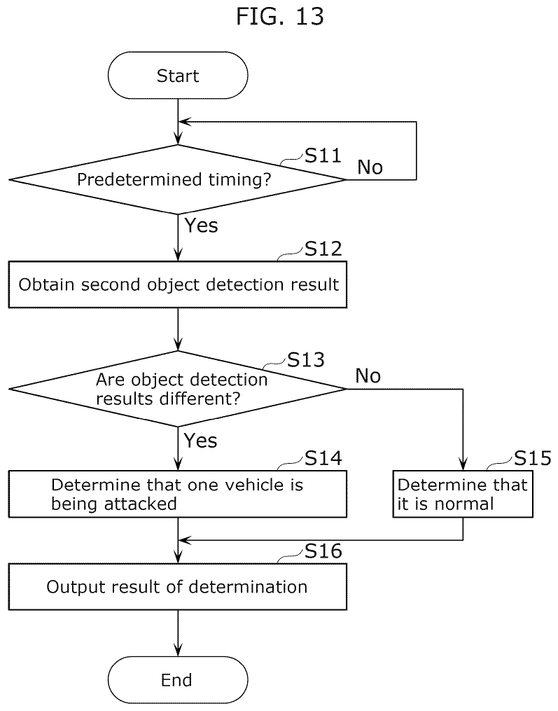

FIG. 13 is a flowchart illustrating one example of the anomaly detection method in the anomaly detection system according to the embodiment.

Anomaly detection device 230 of vehicle 200 determines whether it is a predetermined timing (S11). Anomaly detection device 230 goes to step S12 when it is the predetermined timing (Yes in S11), and returns to step S11 when it is not the predetermined timing (No in S11).

The predetermined timing may be a timing at which object detection device 220 obtains a first object detection result and a second object detection result generated at timings corresponding to each other. The predetermined timing may be a timing at which vehicle 200 and other vehicle 200 are included in the predetermined region. In this case, anomaly detection device 230 has obtained the position of vehicle 200 and the position of other vehicle 200, and performs determination in step S11 based on the position of vehicle 200 and the position of other vehicle 200 obtained. The predetermined timing may be a time when vehicle 200 or other vehicle 200 detects an object in the traveling direction. In this case, anomaly detection device 230 determines that the predetermined timing is the case where the first object detection result indicates that an object is detected in the traveling direction of vehicle 200 or the case where the second object detection result indicates that an object is detected in the traveling direction of other vehicle 200.

Anomaly detection device 230 obtains the object detection result (second object detection result) of other vehicle 200 (S12).

Anomaly detection device 230 compares the first object detection result and the second object detection result, and determines whether the first object detection result and the second object detection result are different (S13).

When the first object detection result and the second object detection result are different (Yes in S13), anomaly detection device 230 determines that one of vehicle 200 and other vehicle 200 is being attacked (S14).

When the first object detection result and the second object detection result are the same (No in S13), anomaly detection device 230 determines that it is normal (that is, vehicle 200 and other vehicle 200 are not attacked) (S15).

Anomaly detection device 230 outputs the result of determination in step S14 or the result of determination in step S15 (S16). Specifically, when the processing goes through step S14, anomaly detection device 230 outputs the result of determination that one vehicle 200 is being attacked; and when the processing goes through step S15, anomaly detection device 230 outputs the result of determination that it is normal.

### [Principle of False Detection]

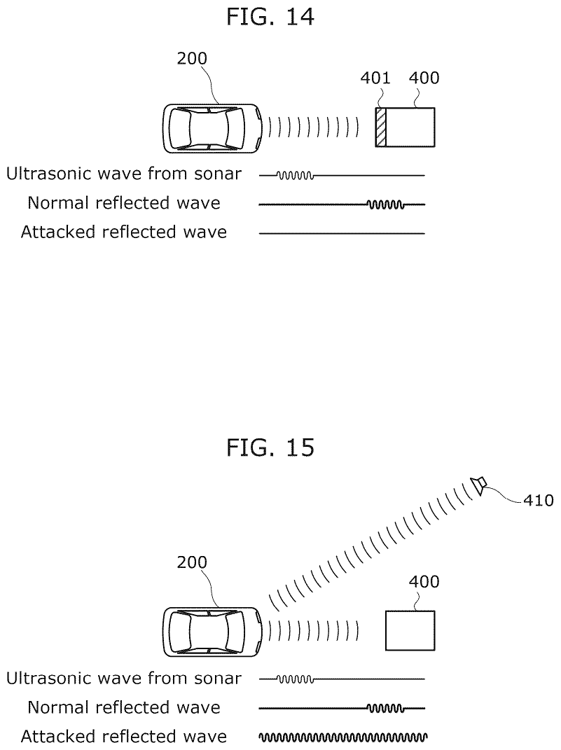

FIGS. 14 to 16 are diagrams for illustrating a method of causing the object detection device to perform false detection.

FIG. 14 illustrates an example in which absorption material 401 which absorbs the ultrasonic wave from the sonar is bonded to the surface of object 400 near vehicle 200, the object being located in the traveling direction of vehicle 200. Thereby, the ultrasonic wave emitted from the sonar of vehicle 200 is absorbed by absorption material 401, and is not reflected. Thus, while the wave having a frequency corresponding to the ultrasonic wave is measured in the case of the normal reflected wave which is assumed to be reflected when absorption material 401 is not bonded, the wave having a frequency corresponding to the ultrasonic wave is not measured in the case of the attacked reflected wave. For this reason, vehicle 200 may misidentify that no object is present in the traveling direction.

FIG. 15 illustrates an example in which a jamming ultrasonic wave is emitted to vehicle 200 from jammer 410 that emits an ultrasonic wave. Because object 400 is present in the traveling direction of vehicle 200 and the ultrasonic wave emitted from vehicle 200 is reflected from object 400, vehicle 200 can detect the ultrasonic wave reflected from object 400. However, vehicle 200 further continuously receives the ultrasonic wave from jammer 410, and therefore the attacked reflected wave continuously includes the ultrasonic wave. This may cause vehicle 200 to be incapable of determining whether an object is present in the traveling direction. For this reason, vehicle 200 may misidentify that no object is present in the traveling direction.

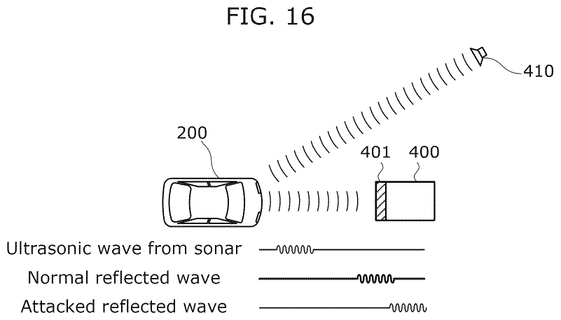

FIG. 16 illustrates an example in which absorption material 401 which absorbs the ultrasonic wave from the sonar is bonded to the surface of object 400 near vehicle 200, the object being located in the traveling direction of vehicle 200, and a jamming ultrasonic wave is emitted to vehicle 200 from jammer 410 that emits an ultrasonic wave. When jammer 410 emits an ultrasonic wave to vehicle 200 to camouflage the distance to object 400, that is, emits an ultrasonic wave to vehicle 200 such that a delayed phase is detected as illustrated in FIG. 16, vehicle 200 may misidentify that object 400 is present in a position farther than the actual distance.

As described above, due to an attack against detection of an object by vehicle 200, vehicle 200 may perform false detection of the presence/absence of the object and/or the position of the object. Although an attack against the sonar has been described in FIGS. 14 to 16, an attack against LIDAR can also be implemented by a similar method.

### [Principle of Detection of Attack]

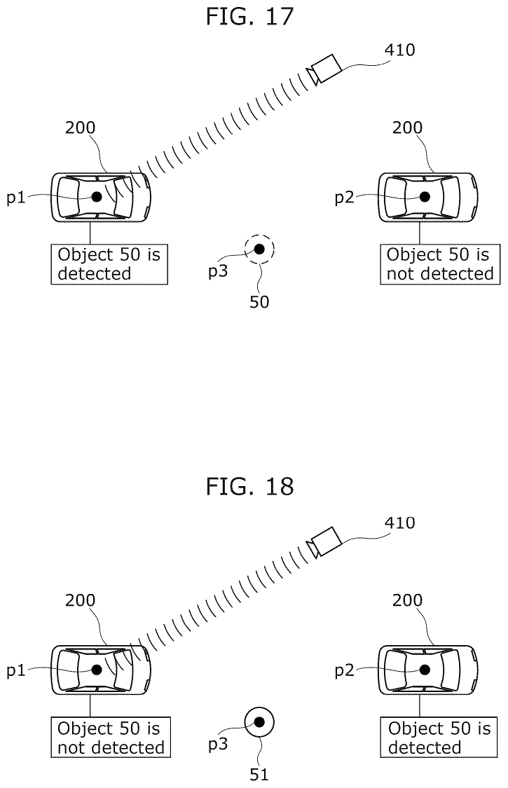

FIGS. 17 and 18 are diagrams for illustrating the principle to detect an attack which causes false detection of an object.

FIG. 17 is a diagram for illustrating an example in which an attack which causes vehicle 200 to perform false detection that object 50 which is not present is present in position p1.

FIG. 17 illustrates vehicle 200 in position p1, vehicle 200 in position p2 in front of vehicle 200 in position p1, and jammer 410 which emits a jamming ultrasonic wave and causes vehicle 200 to perform false detection that there is object 50, which is actually not present in the vicinity of vehicle 200. By emitting a jamming ultrasonic wave for causing vehicle 2 to perform false detection of object 50 to vehicle 200, jammer 410 causes vehicle 200 to perform false detection that object 50 is present in position p3. On the other hand, although jammer 410 can attack vehicle 200 in position p1, it is difficult to simultaneously attack vehicle 200 in position p2 which is traveling in front of vehicle 200 in position p1. Even if jammer 400 can attack these two vehicles simultaneously, it is difficult to cause two vehicles 200 to perform false detection that object 50 is present in the same position. For this reason, when at least one of two vehicles 200 are being attacked, it is highly possible that the first object detection result of vehicle 200 in position p1 does not match the second object detection result of vehicle 200 in position p2. Thus, by comparing the first object detection result and the second object detection result, it can be determined whether at least one of two vehicles 200 is being attacked.

As described above, when the first object detection result and the second object detection result are compared, the coordinates thereof are converted to one of the coordinate systems. For example, using position p1, position p2, and the second object detection result, the second object detection result indicating the relative position of position p3 where position p2 is regarded as a reference is converted to the second object detection result indicating the relative position of position p3 where position p1 is regarded as a reference. Thereby, the first object detection result and the second object detection result can be easily compared in the coordinate system where position p1 is regarded as a reference.

FIG. 18 is a diagram for illustrating an example in which an attack which causes vehicle 200 in position p1 to perform false detection that object 51 present is not present.

FIG. 18 illustrates vehicle 200 in position p1, vehicle 200 in position p2 in front of vehicle 200 in position p1, and jammer 410 which emits a jamming ultrasonic wave to cause vehicle 200 to perform false detection that object 51 present in the vicinities of these vehicles 200 is not present. Although not illustrated, an ultrasonic wave absorption material may be bonded to the surface of object 51. By emitting a jamming ultrasonic wave for causing vehicle 200 to perform false detection of object 50 to vehicle 200, jammer 410 causes vehicle 200 to perform false detection that object 50 is present in position p3. On the other hand, as in the case of FIG. 17, although jammer 410 can attack vehicle 200 in position p1, it is difficult to simultaneously attack vehicle 200 in position p2 which is traveling in front of vehicle 200 in position p1. Even if jammer 400 can attack these two vehicles simultaneously, it is difficult to cause two vehicles 200 to perform false detection that object 50 is present in the same position. For this reason, when at least one of two vehicles 200 is being attacked, it is highly possible that the first object detection result of vehicle 200 in position p1 does not match the second object detection result of vehicle 200 in position p2. Thus, by comparing the first object detection result and the second object detection result, it can be determined whether at least one of two vehicles 200 is being attacked.

Since this description is also applied to the case where vehicle 200 is subjected to an attach which causes vehicle 200 to perform false detection that an object is located in a position different from the actual position, by comparing the first object detection result and the second object detection result, an attack against at least one of vehicle 200 or other vehicle 200 can be detected.

### Another Example of Object Detection Result

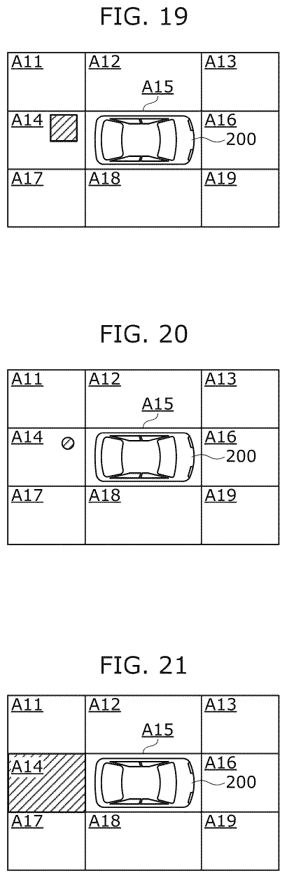

Another example of object detection result will be described with reference to FIGS. 19 to 21.

FIG. 19 is a diagram illustrating an example of the object detection result when an object is detected using the sonar. FIG. 20 is a diagram illustrating an example of the object detection result when an object is detected using LIDAR. FIG. 21 is a diagram illustrating an example of the object detection result after processing to convert the object detection results by the sonar and LiDAR into a common format. In FIG. 19, a hatched square within region A14 represents an object detection result when the sonar is used. In FIG. 20, a hatched circle within region A14 represents an object detection result when LiDAR is used.

When an object is detected using the sonar, the precision of the position of the object to be detected is lower than that when the object is detected using LiDAR. Thus, the region in which the object is present is larger than that in the detection result by LiDAR. Thus, even when the object is the same, the region where the object is highly possibly present is different according to the precision of the sensor. In other words, when the object in the same position is detected using sensors having different precisions, it is possible that the first object detection result may be different from the second object detection result. For this reason, for example, the region in the vicinity of vehicle 200 may be divided into eight regions A11 to A14 and A16 to A19, and information indicating that the object is present or not in these eight regions A11 to A14 and A16 to A19 may be defined as the object detection result. Thereby, for example, as illustrated in FIG. 21, the object detection result (hatched square) illustrated in FIG. 19 and the object detection result (hatched circle) illustrated in FIG. 20 are similarly converted to the object detection results indicating that the object is present in region A14. Thus, irrespective of the precision of the sensor, by converting the object detection results into a common format, it can be easily determined whether two object detection results are different.

### Effects

Anomaly detection device 230 according to the present embodiment includes obtainer 231 that obtains a first object detection result generated by a first object detection device (object detection device 220) that is included in a first apparatus (vehicle 200) which is a vehicle and detects an object in the vicinity of the first apparatus, and a second object detection result generated by a second object detection device that is included in a second apparatus (other vehicle 200) in the vicinity of the first apparatus and detects an object in the vicinity of the second apparatus; determiner 232 that determines whether at least one of the first apparatus or the second apparatus is being attacked, by comparing the first object detection result and the second object detection result; and outputter 233 that outputs a result of determination by determiner 232.

In this configuration, by comparing the first object detection result and the second object detection result, it is determined whether at least one of the first apparatus or the second apparatus is being attacked. Thus, for example, if the first object detection result and the second object detection result are different, it can be detected that an attack to cause the object detection device to perform false detection is being executed. Thus, influences by an attack that causes the object detection device to perform false detection and affects travel control of the vehicle can be reduced.

In anomaly detection device 230 according to the present embodiment, obtainer 231 successively obtains first object detection results successively generated by the first object detection device, and successively obtains second object detection results successively generated by the second object detection device. Determiner 232 successively determines whether at least one of the first apparatus or the second apparatus is being attacked, by comparing, among the first object detection results and the second object detection results, a first object detection result and a second object detection result which are generated at timings corresponding to each other.

In this configuration, it can be successively detected that an attack that causes the object detection device to perform false detection is being executed.

In anomaly detection device 230 according to the present embodiment, obtainer 231 further obtains a first position of the first apparatus when the first object detection device generates the first object detection result, and a second position of the second apparatus when the second object detection device generates the second object detection result. Determiner 232 determines whether at least one of the first apparatus or the second apparatus is being attacked, by comparing the first object detection result generated when the first position is included in a predetermined region and the second object detection result generated when the second position is included in the predetermined region.

In this configuration, for example, when the predetermined region is subjected to an attack that affects travel control of the vehicle and it is highly possible that the vehicle cannot travel normally, the attack can be detected. Thus, the possibility that the vehicle cannot travel normally can be reduced.

In anomaly detection device 230 according to the present embodiment, determiner 232 determines whether at least one of the first apparatus or the second apparatus is being attacked, by comparing the first object detection result and the second object detection result, the first object detection result indicating that an object is detected in a traveling direction of the first apparatus.

In this configuration, it can be determined whether the object detected by the first apparatus comes from false detection.

In anomaly detection device 230 according to the present embodiment, determiner 232 converts the first object detection result and the second object detection result into coordinates in a common coordinate system, and determines whether the first object detection result and the second object detection result after the conversion are different. When the first object detection result and the second object detection result after the conversion are different, determiner 232 determines that at least one of the first apparatus or the second apparatus is being attacked.

In this configuration, by comparing the first object detection result and the second object detection result, it can be easily determined whether the objects detected by two apparatuses are the same. When the objects detected by two apparatuses are different, it can be determined that at least one of the first apparatus or the second apparatus is being attacked.

In anomaly detection device 230 according to the present embodiment, the first object detection result indicates whether an object is present in a plurality of regions where a region in the vicinity of the first apparatus is preliminarily set. The second object detection result indicates whether an object is present in a plurality of regions where a region in the vicinity of the second apparatus is preliminarily set.

In this configuration, by comparing the first object detection result and the second object detection result, it can be easily determined whether the objects detected by two apparatuses are the same.

### Modification

(1) In the embodiment above, the presence/absence of at least one of two vehicles 200 is determined by determining whether two object detection results generated by the object detection devices included in two vehicles 200 are different, but it can be determined by any other method. For example, by comparing three object detection results generated by object detection devices included in three vehicles 200, one vehicle 200 as a target to be attacked may be identified.

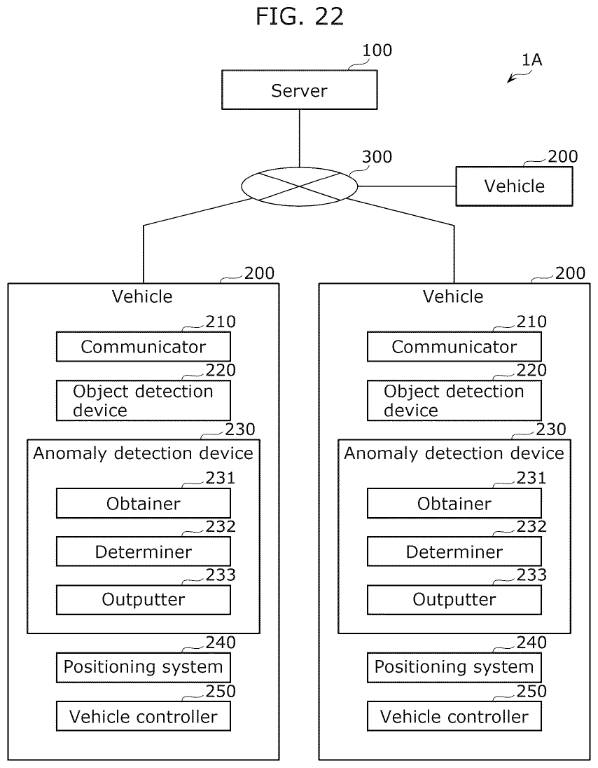

FIG. 22 is a block diagram illustrating one example of the functional configuration of the anomaly detection system according to Modification (1).

Unlike anomaly detection system 1 according to the embodiment, anomaly detection system 1A according to Modification (1) includes three vehicles 200. Anomaly detection device 230 included in three vehicles 200 executes different processing from that in anomaly detection system 1. Other configurations are the same as those in anomaly detection system 1 according to the embodiment, and thus only differences will be mainly described.

Obtainer 231 obtains two object detection results generated by object detection devices 220 of two other vehicles 200. Specifically, obtainer 231 obtains a second object detection result detected by one of two other vehicles 200, as well as a third object detection result generated by object detection device 220 (third object detection device) which is the other of two other vehicles 200 and detects an object in the vicinity of this other vehicle 200.

When determiner 232 compares a first object detection result, a second object detection result, and a third object detection result generated by object detection devices 220 included in vehicles 200, and identifies one object detection result different from two other object detection results among the three object detection results including the first object detection result, the second object detection result, and the third object detection result, determiner 232 determines that the vehicle (apparatus) including the object detection device that generates the one object detection result identified is being attacked.

Anomaly detection device 230 may obtain three or more object detection results from three or more other vehicles 200. Even in this case, anomaly detection device 230 compares four or more object detection results generated by vehicles including vehicle 200 and three or more other vehicles 200, and determines whether a majority of the object detection results match. When the majority of the object detection results match and a non-matching object detection result is present, it may be determined that the vehicle including the object detection device which generates the non-matching object detection result is being attacked. In the above determination, instead of determining whether the majority of the object detection results match, it may be determined whether a larger number of object detection results than the majority thereof match. In other words, the threshold used in determination may be changed. For example, this threshold may be changed according to the number of object detection results to be compared.

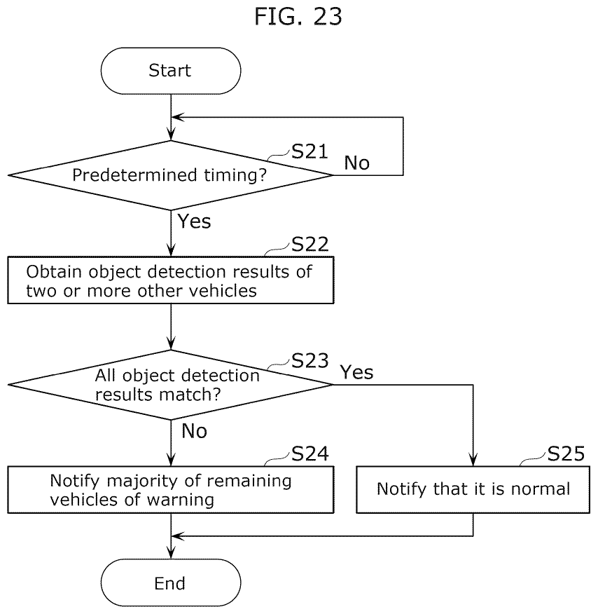

FIG. 23 is a flowchart illustrating one example of the anomaly detection method in the anomaly detection system according to Modification (1).

Anomaly detection device 230 of vehicle 200 determines whether it is predetermined timing (S21). Anomaly detection device 230 goes to step S22 when it is the predetermined timing (Yes in S21), and returns to step S21 when it is not the predetermined timing (No in S21). The predetermined timing is as defined in the embodiment.

Anomaly detection device 230 obtains object detection results (second object detection result, third object detection result) of two or more other vehicles 200 (S22).

Anomaly detection device 230 determines whether all of the object detection results match (S23).

When all of the object detection results do not match (No in S23), anomaly detection device 230 determines that vehicles 200 corresponding to a majority of remaining object detection results are being attacked, and notifies vehicles 200 identified as being attacked of a warning (S24). When it is determined that the majority of object detection results do not match, it may be determined that vehicles 200 corresponding to non-matching object detection results are being attacked, and may notify these vehicles of a warning.

When all of the object detection results match (Yes in S23), anomaly detection device 230 determines that it is normal (that is, vehicle 200 and other vehicles 200 are not attacked), and notifies these vehicles of the result (S25).

Thus, by comparing the object detection results detected in three or more vehicles 200, it is possible to identify vehicle 200 which is being attacked. For this reason, for vehicle 200 which is being attacked, a notification indicating that vehicle 200 is being attacked may be sent to the driver of vehicle 200, autonomous driving control may be executed using the object detection result obtained by the sensor of other vehicle 200 in the vicinity of vehicle 200 until vehicle 200 is switched to manual driving or stops in a safe place (a road shoulder), or a notification indicating that vehicle 200 is being attacked may be sent to a driver of other vehicle 200 in the vicinity of vehicle 200.

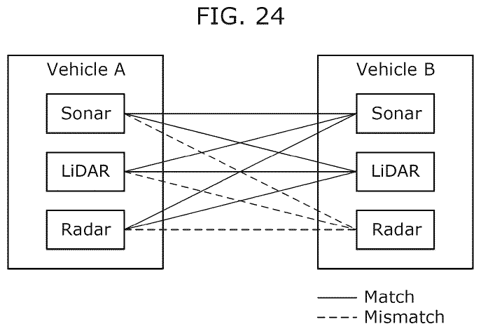

(2) Although other vehicle 200 includes object detection device 220 in the embodiment above, not only other vehicle 200 includes object detection device 220, but also any apparatus other than vehicle 200, such as a roadside unit, may include it. In other words, the second apparatus is not limited to an apparatus having a function to travel, such as a vehicle, and may be implemented by an apparatus that does not travel but stops. Such a second apparatus such as a roadside unit may have a configuration of vehicle 200 excluding positioning system 240 and vehicle controller 250, for example. Specifically, the second apparatus not having the traveling function, such as a roadside unit, includes communicator 210, object detection device 220, and anomaly detection device 230. Communicator 210, object detection device 220, and anomaly detection device 230 have the same configurations as those of the components having the same names which are already described in the embodiment, and thus their detailed descriptions will be omitted. The second apparatus may preliminarily store the position in which the second apparatus is disposed, and may use the preliminarily stored position instead of the position detected by positioning system 240.
(3) FIG. 24 is a diagram for illustrating an example in which vehicles each include a plurality of various sensors.

For example, a first object detection device included in vehicle A includes a sonar (a first sensor of a first type), LiDAR (a second sensor of a second type), and a radar, and a second object detection device included in vehicle B includes a sonar (a third sensor of the first type), LiDAR (a fourth sensor of the second type), and a radar. In this case, as illustrated in FIG. 24, for example, based on the detection result of a sensor having a mismatch, it may be determined that the radar is being attacked.

(4) Although vehicle 200 includes anomaly detection device 230 in the embodiment above, server 100 may include it.

### Others

In the embodiment above, the components may be configured of dedicated hardware, or may be implemented by executing software programs suitable for the components. The components may be implemented by a program executer, such as a CPU or a processor, reading out and executing software programs recorded on a recording medium such as a hard disk or semiconductor memory. Here, software for implementing a production management apparatus, a production management system, or the like in the embodiment above is a program for causing a computer to execute the steps included in the flowcharts illustrated in the drawings.

The present disclosure also covers the following cases.

(1) Specifically, the devices above are a computer system configured of a microprocessor, a ROM, a RAM, a hard disk unit, a display unit, a keyboard, a mouse, and the like. The RAM or the hard disk unit stores computer programs. When the microprocessor operates according to the computer programs, the devices achieve their functions. Here, the computer programs are each configured of a combination of command codes to give instructions to a computer to achieve predetermined functions.

(2) Part or all of the components constituting each of the devices may be configured of a single system LSI (Large Scale Integration: large scale integrated circuit). The system LSI is an ultra-multifunctional LSI produced by integrating a plurality of constituents on a single chip, and specifically is a computer system including a microprocessor, a ROM, and a RAM. The RAM stores computer programs. When the microprocessor operates according to the computer programs, the system LSI achieves its functions.

(3) Part or all of the components constituting the devices may be configured of an IC card or a single module which is detachably attachable to the devices. The IC card or the module is a computer system configured of a microprocessor, a ROM, a RAM, and the like. The IC card or the module may include the above ultra-multifunctional LSI. When the microprocessor operates according to a computer program, the IC card or the module achieves its functions. This IC card or module may have tamper proofness.

(4) The present disclosure may be the methods described above. These methods may be a computer program implemented by causing a computer to execute these, or may be digital signals composed of the computer program.

The present disclosure may be the computer program or the digital signal recorded on a computer-readable recording medium, such as a flexible disc, a hard disk, a CD-ROM, a MO, a DVD, a DVD-ROM, a DVD-RAM, a Blu-ray (registered trademark) Disc (BD), or a semiconductor memory. The present disclosure may also be the digital signals recorded on these recording media.

The present disclosure may be the computer program or the digital signals transmitted via an electrical communication line, a wireless or wired communication line, a network such as the Internet, or data broadcasting.

The present disclosure may be a computer system including a microprocessor and a memory, the memory may store the computer program, and the microprocessor may operate according to the computer program.

The present disclosure may be implemented by an independent different computer system by recording the program or the digital signals on the recording medium and transferring it or transferring the program or the digital signals via the network or the like.

(5) The embodiment and the modifications above may be combined.

While an embodiment has been described herein above, it is to be appreciated that various changes in form and detail may be made without departing from the spirit and scope of the present disclosure as presently or hereafter claimed.

### Further Information about Technical Background to this Application

The disclosure of the following patent application including specification, drawings, and claims is incorporated herein by reference in their entirety: Japanese Patent Application No. 2023-131646 filed on Aug. 10, 2023.

### INDUSTRIAL APPLICABILITY

The present disclosure is useful as anomaly detection devices that can reduce influences caused by attacks affecting travel control of vehicles, excluding cyberattacks.

1. An anomaly detection device comprising:
a processor; and
a non-transitory memory that stores a program,
wherein the processor executes the program to operate the anomaly detection device as:
an obtainer that obtains a first object detection result generated by a first object detection device that is included in a first apparatus which is a vehicle and detects an object in the vicinity of the first apparatus, and a second object detection result generated by a second object detection device that is included in a second apparatus in the vicinity of the first apparatus and detects an object in the vicinity of the second apparatus;
a determiner that determines whether at least one of the first apparatus or the second apparatus is being attacked, by comparing the first object detection result and the second object detection result; and
an outputter that outputs a result of determination by the determiner.

2. The anomaly detection device according to claim 1,
wherein the obtainer successively obtains first object detection results successively generated by the first object detection device, and successively obtains second object detection results successively generated by the second object detection device, and
the determiner successively determines whether at least one of the first apparatus or the second apparatus is being attacked, by successively comparing, among the first object detection results and the second object detection results successively obtained by the obtainer, a first object detection result and a second object detection result which are generated at timings corresponding to each other.

3. The anomaly detection device according to claim 1,
wherein the obtainer further obtains a first position of the first apparatus when the first object detection device generates the first object detection result, and a second position of the second apparatus when the second object detection device generates the second object detection result, and
the determiner determines whether at least one of the first apparatus or the second apparatus is being attacked, by comparing the first object detection result generated when the first position is included in a predetermined region and the second object detection result generated when the second position is included in the predetermined region.

4. The anomaly detection device according to claim 1,
wherein the determiner determines whether at least one of the first apparatus or the second apparatus is being attacked, by comparing the first object detection result and the second object detection result, the first object detection result indicating that an object is detected in a traveling direction of the first apparatus.

5. The anomaly detection device according to claim 1,
wherein the determiner converts the first object detection result and the second object detection result into coordinates in a common coordinate system, and determines whether the first object detection result and the second object detection result after the conversion are different, and
when the first object detection result and the second object detection result after the conversion are different, the determiner determines that at least one of the first apparatus or the second apparatus is being attacked.

6. The anomaly detection device according to claim 5,
wherein the first object detection result indicates whether an object is present or not in each of a plurality of regions set in advance as a region in the vicinity of the first apparatus, and
the second object detection result indicates whether an object is present or not in each of a plurality of regions set in advance as a region in the vicinity of the second apparatus.

7. The anomaly detection device according to claim 1,
wherein the first object detection device includes a first sensor of a first type and a second sensor of a second type,
the second object detection device includes a third sensor of the first type and a fourth sensor of the second type,
the first object detection result includes a first detection result from the first sensor and a second detection result from the second sensor,
the second object detection result includes a third detection result from the third sensor and a fourth detection result from the fourth sensor,
the determiner compares the first detection result, the second detection result, the third detection result, and the fourth detection result, and
when the determiner identifies one detection result different from three other detection results among four detection results including the first detection result, the second detection result, the third detection result, and the fourth detection result, the outputter notifies an other vehicle of a sensor type of the sensor from which the one detection result identified has been obtained.

8. The anomaly detection device according to claim 1,
wherein the obtainer further obtains a third object detection result generated by a third object detection device that is included in a third apparatus which is a vehicle different from the first apparatus and detects an object in the vicinity of the third apparatus, and
when the determiner compares the first object detection result, the second object detection result, and the third object detection result, and identifies one object detection result different from two other object detection results among three object detection results including the first object detection result, the second object detection result, and the third object detection result, the determiner determines that the apparatus including the object detection device from which the one object detection result identified has been obtained is being attacked.

9. The anomaly detection device according to claim 1,
wherein the second apparatus is a vehicle or a roadside unit that is different from the first apparatus.

10. An anomaly detection method comprising:
obtaining a first object detection result generated by a first object detection device that is included in a first apparatus which is a vehicle and detects an object in the vicinity of the first apparatus;
obtaining a second object detection result generated by a second object detection device that is included in a second apparatus in the vicinity of the first apparatus and detects an object in the vicinity of the second apparatus;
determining whether at least one of the first apparatus or the second apparatus is being attacked, by comparing the first object detection result and the second object detection result; and
outputting a result of determination in the determining.
